(19) United States
(12) Patent Application Publication
(10) Pub. No.: US 2016/0170389 A1
(43) Pub. Date: Jun. 16, 2016

(54) SMART HOME CONTROL APPARATUS, SMART HOME CONTROL METHOD AND SMART HOME CONTROL SYSTEM

(71) Applicant: SAMSUNG ELECTRO-MECHANICS CO., LTD., Suwon-si (KR)

(72) Inventors: Hyung Jin IM, Suwon-si (KR); Jong Heum PARK, Suwon-si (KR)

(73) Assignee: SAMSUNG ELECTRO-MECHANICS CO., LTD., Suwon-si (KR)

(21) Appl. No.: 14/964,926

(22) Filed: Dec. 10, 2015

(30) Foreign Application Priority Data
Dec. 12, 2014 (KR) 10-2014-0179719
Mar. 16, 2015 (KR) 10-2015-0035911

(51) Int. Cl. G05B 15/02; H04W 4/00; G05G 1/02

(52) U.S. Cl. CPC G05B 15/02; G05G 1/02; H04W 4/008

(57) ABSTRACT

A smart home control system including a mechanical button; an external programming terminal; and a controller configured to receive and store a control value from the external programming terminal, and generate and output a smart home control signal according to the control value, wherein an operating state of the button is determined by the smart home control signal.

### CROSS-REFERENCE TO RELATED APPLICATIONS

This application claims the benefit under 35 USC 119(a) of Korean Patent Application Nos. 10-2014-0179719 filed on Dec. 12, 2014 and 10-2015-0035911 filed on Mar. 16, 2015, in the Korean Intellectual Property Office, the disclosures of which are incorporated herein by reference for all purposes.

### BACKGROUND

1. Field

The following description relates to a smart home control apparatus, a smart home control method, and a smart home control system.

2. Description of Related Art

In accordance with the development of information technology (IT), home networks such as smart home and office technology are becoming increasingly more common. Further, in accordance with rapid aging of the population and an increase in welfare necessity for children and the disabled, as well as an increased awareness of residential environments and health care for adults in modern society, the above-mentioned smart home has also been applied to residential environment management and a health care control. Further, research into smart homes has been conducted from various viewpoints in an attempt to integrally control home appliances such as TVs, refrigerators, and the like to an attempt to integrally control light fixtures such as light emitting diodes (LEDs).

Accordingly, research into a smart home control system for integrally controlling the smart home or a proposal therefor has been conducted. In accordance with such trends, a system in which the integral control for the smart home is wirelessly performed using an electronic device such as a smartphone has been recently, widely used. However, since the smart home control system as described above may only implement only functions stored in an internal memory, it is very difficult to freely set, change, and add control values of a form desired by a user without being limited to time and place. In addition, since the smart home control system as described above may merely perform controls using an electronic device such as a smartphone, it is very difficult for the elderly or children who are unaccustomed to using electronic devices such as smartphones to perform the control of the smart home control system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a smart home control apparatus a smart home control method, and a smart home control system capable of freely setting/changing/adding control values having a form desired by a user anywhere and at anytime by external programming terminals (wired and wireless terminals, etc.) and directly performing an integral control for a smart home by user manipulation such as mechanical buttons on the basis of the set/changed/added control values.

In another general aspect, a smart home control system includes a mechanical button; an external programming terminal; and a controller configured to receive and store a control value from the external programming terminal, and generate and output a smart home control signal according to the control value, wherein an operating state of the button is determined by the smart home control signal.

In another general aspect, a smart home control method includes generating a control value corresponding to an operating state of each of a plurality of mechanical buttons; receiving and storing the control value from an external programming terminal; and generating and outputting a smart home control signal according to the operating state of each button on the basis of the stored control value.

Other features and aspects will be apparent from the following detailed description, the drawings, and the claims.

### BRIEF DESCRIPTION OF DRAWINGS

FIG. 1 is a block diagram of an example of a smart home control system with a smart home control apparatus;

FIG. 2 is a diagram illustrating an example of a programmable user interface (UI) module;

FIG. 3 is a flowchart illustrating an example of a smart home control operation; and

FIG. 4 is a diagram schematically illustrating an example of the smart home control system of FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

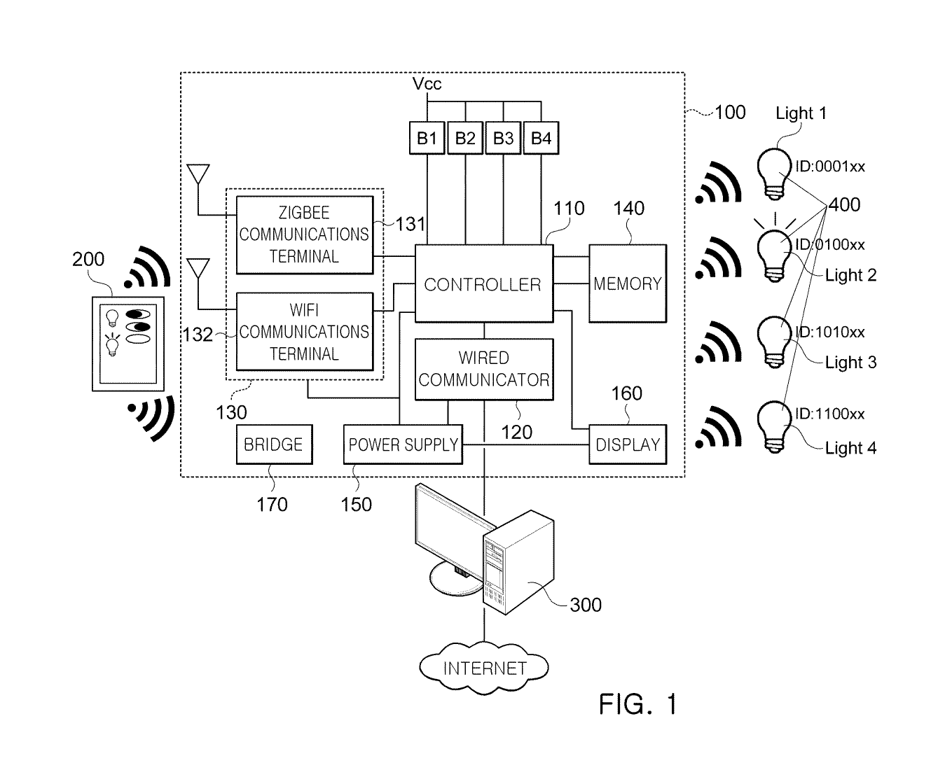

FIG. 1 illustrates a block diagram of a smart home control system 100 in which a smart home control apparatus is adopted, according to an embodiment. In this case, a controller 110 illustrated in FIG. 1 corresponds to the smart home control apparatus.

Although the present embodiment illustrates a case in which the smart home control system is applied to a smart switch in which a mechanical button, or the like, is implemented, the following description is not limited thereto, and any configuration may also be used as long as it is a configuration for controlling a device in a smart home. The smart home control system 100 includes components that perform functions such as a variety of sensing, communications, and system processes in relation to residential environment management, home appliance management, lighting management, and health care.

For example, the smart home control system 100 includes mechanical buttons B1 to B4, the controller 110, a wired communicator 120, a wireless communicator 130, a memory 140, and a power supply 150, as illustrated in FIG. 1. Here, the respective components in FIG. 1 are connected to each other through a standard interface (not illustrated) of the smart home control system. The mechanical buttons B1 to B4 may be implemented as at least one switch or function key. However, the buttons are not limited thereto, and any component may be applied as long as it is a mechanical component capable of generating a smart home control signal according to a button operating state depending on manipulation by a user.

The controller 110, performs an overall control function of the system, controls other components through software, firmware or hardware. Therefore, the controller 110 may perform a variety of software functions of a smart home control such as residential environment management, home appliance management, health care, lighting management, and others.

The controller 110 controls the respective processes of software operated by the smart home control system 100, so as to be operated in harmony. For example, in a case in which a lighting management control is performed, the controller 110 may include a variety of components for performing software functions such as wired lighting control, wireless smart lighting control, dimming/on-off for each of a number of regions, remote/security wireless control, an illumination/color temperature control for each of the regions, fault diagnosis/life prediction of light fixtures, and other control and sensing of devices of the smart house.

The wired communicator 120 performs a wired communications functions in the smart home control system 100. For example, when the lighting management control is performed, the wired communicator 120 inputs a control value corresponding to a lighting control command to the controller 110 through the Internet, using a wired connection, for example Ethernet, and also supports the lighting control using various wired communications protocols in addition to the above-mentioned Ethernet. For instance, in a case in which lighting management control is performed, the wired communicator 120 receives the lighting control value, signal or information from an external programming terminal 300 via wired communications such as Ethernet.

The wireless communicator 130 performs wireless communications functions in the smart home control system 100. For example, the wireless communicator 130 receives control information from an external programming terminal 200. The wireless communicator 130 outputs the control information to the controller 110. The controller 110 controls the smart house components accordingly. The external programming terminal 200 uses a local area low power communications functions such as Zigbee, Wi-Fi, Bluetooth, or infrared ray to transmit the control information to the wireless communicator 130. The wireless communicator 130 receives the control value, signal, or information, from the external programming terminal 200 via wireless communications such as Zigbee, Wi-Fi, Bluetooth, or infrared ray.

In addition, the wireless communicator 130 also transmits the smart home control signals generated by buttons B1 to B4 based on the control value, according to the buttons' operating states, to control targets (e.g., lighting fixtures such as LEDs in the case in which the lighting management control is performed, and denoted by reference number 400 in FIG. 1) as described above via wireless communications such as Zigbee, Wi-Fi, Bluetooth, or infrared ray. Therefore, the wireless communicator 130 demodulates a wireless signal (an RF signal) received from a wireless based external programming terminal 200 into a form which can be processed by the controller 110, or modulates the wireless signal into a wireless signal (i.e. an RF signal) which is transmitted through an antenna. Therefore, the wireless communicator 130 may be a Bluetooth transceiver, a WiFi transceiver, a Zigbee Transceiver, an infrared ray transceiver, or any combination thereof.

Further, the wireless communicator 130 also receives data obtained by monitoring states of the control targets (e.g., lighting fixtures such as the LEDs in the case in which the lighting management control is performed, and denoted by reference number 400 in FIG. 1) as well as the control value as described above via wireless communications.

The above-mentioned wireless communicator 130 includes a Zigbee communications terminal 131 for supporting Zigbee wireless communications and a Wi-Fi communications terminal 132 for supporting Wi-Fi wireless communications, as illustrated in FIG. 1. However, the wireless communicator is not limited thereto, and the may also be a communications terminal or three or more communications terminals, depending on a communications scheme, whether or not a bridge is used.

The wireless based external programming terminal 200 is an electronic device such as a smartphone, a mobile phone, a tablet PC, or a notebook However, the wireless based external programming terminal 200 is not limited thereto, and any kind of electronic device may be used as long as it is an electronic device (e.g., a mobile terminal, or a touchpad) having the local area low power communications function such as Zigbee, Wi-Fi, Bluetooth, infrared ray, or the like.

The wireless based external programming terminal 200 as described above and a wired based external programming terminal 300 (e.g., a desktop or laptop) that communicates with the wired communicator 120 via an Ethernet connection includes a user interface (hereinafter referred to as “UI”), and the UI includes a programmable UI module. The user may set, change, and/or add various programming control values for the smart home control such as residential environment management, home appliance management, health care, lighting management, and the like.

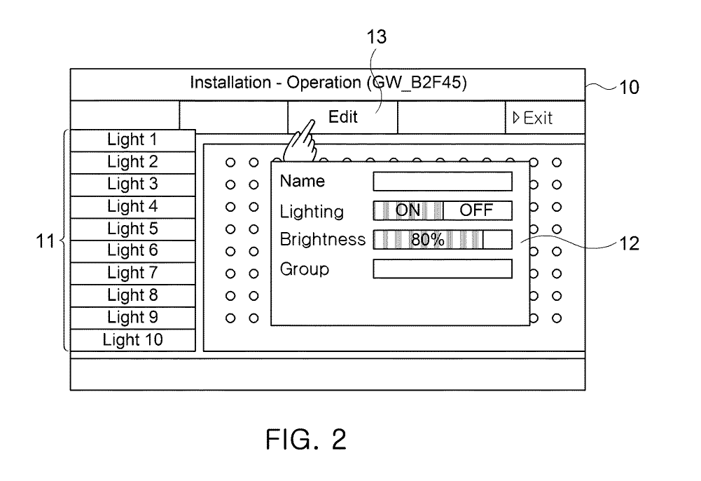

FIG. 2 illustrates an example of a programmable UI module 10 in a case in which the smart home control system 100 performs the lighting management control, wherein the programmable UI module 10 may be operated on an external programming terminal such as a desktop, a smartphone, or a wired and wireless device similar thereto. For example, the left side of the programmable UI module 10 illustrated in FIG. 2 includes names of the respective light sources to be controlled, and displays a light source list 11 that displays the names of the respective light sources. A central portion of the programmable UI module 10 displays an interface 12 that may set, change, add, or any combination thereof, items of control values such as On/Off of the light sources, brightness of the light sources, a group of the light sources, or any combination thereof.

The various programming control values for the light management control may be set, changed, and/or added by the programmable UI module 10, as described above. Here, the set, changed, and/or added control values are provided in the smart home control system 100 (particularly, in the controller) as being applied to a smart switch in a form of firmware, or the like, via wireless communications (Zigbee, WiFi, Bluetooth, or infrared ray) or wired communications (Ethernet).

For example, in a case in which the smart home control system 100 performs lighting management control, the user sets, changes, and/or adds desired lighting control values through the programmable UI module, as described above, and the newly set, changed, and/or added lighting control values are provided by the user via wireless or wired communications. In this case, the controller 110 receives and stores the lighting control values set, changed, and/or added by the programmable UI module and is connected to one or more mechanical buttons B1 to B4 to assign and designate the lighting control value corresponding to an operating state of each of the buttons B1 to B4.

Here, the following Table 1 and Table 2 illustrate firmware contents of the light control values provided through the programmable UI module.

TABLE 1

Command = Switch1 SET
Value = Switch_On Vcc = On
Command = Switch Level 45%
Value = Switched_ON

TABLE 2

Command = Switch1 SET
Value = Switch_Off Vcc = Off
Command = Switch Level 45%
Value = Switched_Off

For example, when the respective buttons B1 to B4 are implemented as a switch, Table 1 illustrates the firmware contents of the light control values that turn on a light source corresponding to an operating state of a button 1 (B1) at brightness of 45%. Table 2 illustrates the firmware contents of the light control values that turn off the light source corresponding to the operating state of the button 1 (B1).

The smart home control system 100 configured as described above eventually transmits the smart home control signals according to the operating state of the respective buttons B1 to B4 on the basis of the assigned and designated light control values to the light fixtures 400, as illustrated in FIG. 1. The smart home control system 100 may perform a group lighting control by a network configuration as well as a separate lighting control, accordingly.

The control processes as described above are illustratively described with reference to the following Table 3 and Table 4, and FIG. 2, wherein Table 3 and Table 4 illustrate an example of the lighting control values which are programmed by the programmable UI module of FIG. 2 and are assigned and designated to correspond to the operating states of the respective buttons, in the case in which the smart home control system 100 performs the lighting management control.

TABLE 3

| | B1 | B2 | B3 | B4 |
|---|---|---|---|---|
| Control Value | On | Off | On | Off |
| Reception Mode | | | | |
| Light Source | On | Off | Off | Off |
| 1(Light 1) | (Lighting) | | | |
| Light Source | Off | On | Off | Off |
| 2(Light 2) | | (Lighting) | | |
| Light Source | Off | Off | On | Off |
| 3(Light 3) | | | (Lighting) | |
| Light Source | Off | Off | Off | On |
| 4(Light 4) | | | | (Lighting) |

For example, in a case in which the lighting control values corresponding to the operating states of the respective buttons B1 to B4 are programmed and are assigned and designated to the controller 110 as in Table 3, when buttons 2 to 4 (B2 to B4) are toggled off (in an off state) and only button 1 (B1) is toggled on (in an on state), the smart home control signals (lighting control signals) are generated accordingly. According to the above-mentioned lighting control signals, a so-called separate lighting control in which only the light source 1 (Light 1) is turned on and light sources 2 to 4 (Lights 2 to 4) are turned off may be performed.

TABLE 4

| | B1 | B2 | B3 | B4 |
|---|---|---|---|---|
| Light Source | On | Off | On | On |
| 1(Light 1) | (Lighting), | | (Lighting), | (Lighting), |
| | 40% | | 100% | 70% |
| | (Brightness) | | (Brightness) | (Brightness) |
| Light Source | On | Off | On | Off |
| 2(Light 2) | (Lighting), | | (Lighting), | |
| | 50% | | 100% | |
| | (Brightness) | | (Brightness) | |
| Light Source | Off | On | On | On |
| 3(Light 3) | | (Lighting), | (Lighting), | (Lighting), |
| | | 80% | 100% | 80% |
| | | (Brightness) | (Brightness) | (Brightness) |
| Light Source | Off | On | On | Off |
| 4(Light 4) | | (Lighting), | (Lighting), | |
| | | 80% | 100% | |
| | | (Brightness) | (Brightness) | |

In addition, in a case in which the lighting control values corresponding to the operating states of the respective buttons B1 to B4 are programmed and are assigned and designated to the controller 110 as in Table 4, when the toggles button 1 (B1) to the on position, the smart home control signal (lighting control signal) may be generated accordingly. According to the above-mentioned lighting control signal, a group lighting control in which the light source 1 (Light 1) is turned on at a brightness of 40%, the light source 2 (Light 2) is turned on at a brightness of 50%, and light sources 3 and 4 (Lights 3 and 4) are turned off may be performed.

As a result, since the smart home control system 100 as described above may freely set, change, and/or add the control values having a form desired by the user through the programmable UI module anywhere and at anytime, the smart home controls (the separate control, the group control, and the like) of various scenarios according to the set, change, and/or addition of the control values may be performed.

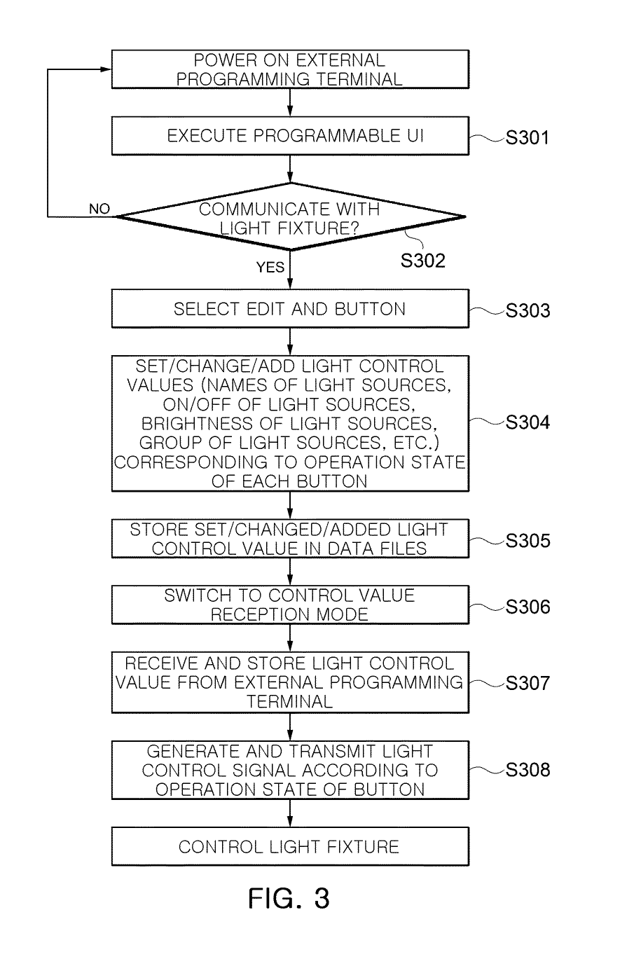

The smart home control system 100 can be switched to a control value reception mode for performing the control value reception from the external programming terminals 200 and 300, in a case in which a predetermined time elapses in a state in which at least one button is pressed, as shown in Table 3. Here, although the smart home control system 100 is switched to the control value reception mode by pressing two buttons for the predetermined time, the method of switching modes is not limited thereto. While the two buttons, B1 and B3, are pressed as illustrated in Table 3 and FIG. 3 to switch to the control value reception mode, the smart home control system 100 may be switched to the control value reception mode wherein one button or any combination of buttons are pressed for a predetermined amount of time.

In addition, the smart home control system 100 may block the control value reception from the external programming terminals 200 and 300 through a method of disabling external access to firmware, or setting passwords. This prevents a control malfunction caused as the newly set, changed, and/or added control values externally received during a process of controlling the control targets according to the operating states of the respective buttons B1 to B4.

Referring again to FIG. 1, the memory 140 is an auxiliary storage and stores the control values received from the external programming terminals 200 and 300, and may also store data necessary to perform a control process (a process such as an operation) of the controller 110.

The power supply 150, which is used as an overall operation power supply of the smart home control system 100 is a battery such as a secondary battery. However, the power supply 150 is not limited thereto, but the power supply 150 may also be power supply components having various forms such as an energy harvester or a switching mode power supply (SMPS). In addition, the power supply 150 may be a portable power supply component (e.g., a portable battery), and in this case, the smart home control system 100 has an advantage of mobility because it does not need to be hard wired into a customer premise power supply.

In addition, the display 160 displays the operating states of the respective buttons B1 to B4, the quantity of power of the power supply 150, and an operating state of the controller 110.The display 160 may be an LED screen; however, the not limited thereto, and may be any form of a display component as long as it visually displays detailed states of the respective components.

The smart home control system 100 may further include a bridge 170 that performs all local area low power communications such as Zigbee, Wi-Fi, Bluetooth, and infrared ray. In this case, the bridge 170 may be a gateway but is not limited thereto. For example, any component may also be used as long as it is a component capable of performing a function as a communications network connection device.

The smart home control system 100 assigns a separate ID to the smart home control target (the control target of residential environment management, home appliance management, health care, lighting management, or the like). For example, in the case in which lighting management control is performed, the smart home control system 100 assigns a separate ID to each of the light fixtures 400 as illustrated in FIG. 1, via initial communications between the external programming terminal 200, the bridge 170, and the light fixtures 400. Thereby, a network for each of the light fixtures 400 is configured.

Hereinafter, a smart home control operation will be illustratively described with reference to FIGS. 1 and 2, Table 3, and Table 4, (the lighting management control will be described by way of example). Here, FIG. 3 illustrates a flowchart illustrating the smart home control operation.

Referring to FIG. 3, after the external programming terminals 200 and 300 are powered on, the programmable UI module 10 included in the external programming terminals 200 and 300 is executed (S301). Thereafter, if an initial communications process between the external programming terminals and the light fixtures 400 is performed (YES in S302), each of the light fixtures 400 are assigned a separate ID.

In this case, the wireless communicator 130 uses an integrated chip (IC) to perform an upper level function, such as a coordinator or a master. In addition, the wireless communications terminal of each of the light fixtures 400 uses the IC to perform a lower level function, such as a slave, or a student.

Thereafter, the lighting control value corresponding to the operating state of each of the mechanical buttons B1 to B4 may be set, changed, and/or added, on the basis of light ID information stored in the external programming terminals 200 and 300. The set, change, and/or addition of the light control value may be freely performed at anytime and anywhere by the programmable UI module (the UI module included in the external programming terminals).

For example, in the programmable UI module 10 illustrated in FIG. 2, an Edit tab 13 disposed above the interface 12 may be clicked, and thus each of the buttons B1 to B4 may be selected (S303), the light control values (e.g., names of the light sources, On/Off of the light sources, brightness of the light sources, and a group of the light sources) corresponding to the operating states of the respective buttons B1 to B4 may be set/changed/added (S304), and the set/changed/added light control values are stored in data files (S305).

Thereafter, the smart home control system is switched into a control value reception mode for receiving the light control values stored as described above (S306), by pressing at least one button for a predetermined time. In this case, the smart home control system 100 receives the light control values, from the external programming terminals 200 and 300 in a form of firmware, via wired or wireless communications; assigns and designates the light control values in order to correspond to the operating states of the buttons B1 to B4; and stores the assigned and designated lighting control values (S307). Thereafter, the smart home control system 100 generates the smart home control signals according to the operating states of the respective buttons B1 to B4 according to the newly set, changed, and/or added light control values and transmits the smart home control signals to the light fixtures 400 (S308).

For example, in a case in which the light control values received from the external programming terminals 200 and 300 are assigned and designated to the controller 110 as in Table 4, when the user presses button 1 (B1), the smart home control signal (lighting control signal) is generated accordingly. According to the above-mentioned lighting control signal, group lighting control is performed in which the light source 1 (Light 1) is turned on at a brightness of 40%, the light source 2 (Light 2) is turned on at a brightness of 50%, and light sources 3 and 4 (Lights 3 and 4) are turned off. Therefore, the smart home control system 100 performs group lighting control (e.g., the control on the basis of the lighting control values assigned and designated as in Table 4) by a network configuration as well as a separate lighting control (e.g., the control on the basis of the light control values assigned and designated as in Table 3), and also performs smart lighting controls of various scenarios according to the set/change/addition of the lighting control values.

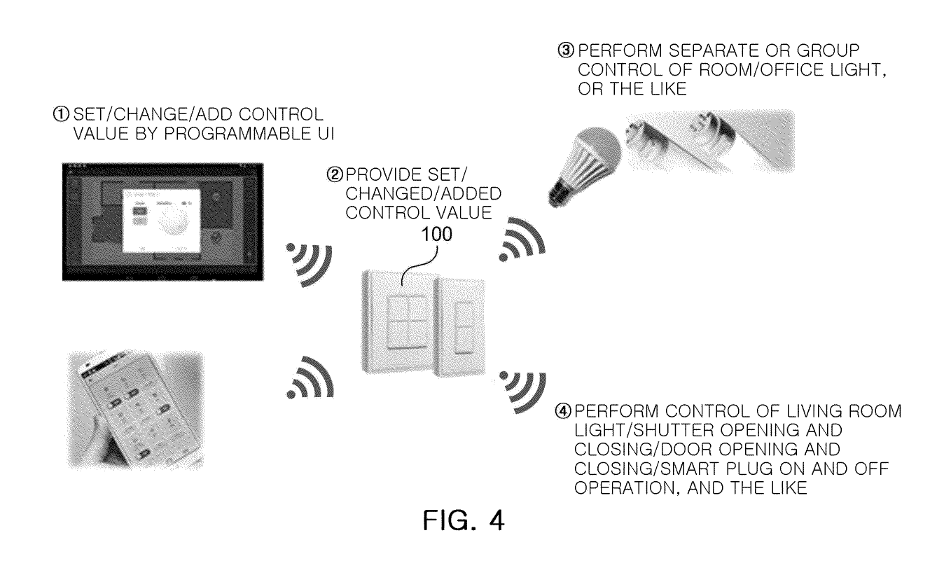

FIG. 4 is a diagram schematically illustrating an example to which the smart home control system 100 of FIG. 1 is applied.

As illustrated in FIG. 4, the user may set, change, and/or add various control values for the smart home control such as residential environment management, home appliance management, health care, and lighting management, using the programmable UI module included in the wired or wireless external programming terminals (\textcircled{1}). Here, the control values which are set, changed, and/or added by the programmable UI module may be provided to the smart home control system 100 and applied to the smart switch via wired or wireless communications. In this case, the control values are assigned and designated in order to correspond to the operation states of the respective buttons and are then stored (\textcircled{2}).

In addition, the smart home control system 100 transmits the smart home control signals, according to the operating states of the buttons, to the control targets on the basis of newly set, changed, and/or added control values by the programmable UI module. Therefore the smart home system 100 controls various scenarios of smart home control such as residential environment management, home appliance management, health care, and lighting management (\textcircled{3}, \textcircled{4}).

The contents described above will be described by way of example, as follows.

First, control values of a room/office light (hereinafter referred to as “first control values”) and control values of a living room light/shutter opening and closing/smart plug on and off switch (hereinafter referred to “second control values”) may be set by the programmable UI module included in the external programming terminals (\textcircled{1}). Here, the first and second control values set by the programmable UI module are provided to the smart home control system 100 and applied to the smart switch via wired or wireless communications. In this case, the first and second control values are assigned and designated in order to correspond to the operating states of the respective buttons and are then stored (\textcircled{2}).

In addition, in a case in which a button corresponding to the first control value is pressed, the smart home control system 100 may transmit the light control signal generated accordingly to the room/office light fixtures, or the like, and perform the separate or group control of the room/office light, or the like (\textcircled{3}).

In addition, if another button corresponding to the second control value is pressed, the smart home control system 100 transmits the smart home control signal generated accordingly to the living room light fixture/shutter/door/smart plug and performs the smart home controls such as the living room light/shutter opening and closing/door opening and closing/smart plug on and off operation, (\textcircled{4}). Therefore, by the configurations and operations described above, the smart home control system 100 may freely set/change/add the control values as desired by the user anywhere and at any time. Thus, the smart home controls of various scenarios are performed through the set/change/addition of the control values.

In addition, since the smart home control system 100 may directly perform the smart home control through user manipulation such as the mechanical buttons in addition to the electronic device such as the smartphone, the elderly, children, and those who are unaccustomed to using electronic devices, such as smartphones, may also easily control the various components of the smart home.

As set forth above, the control values having the form desired by the user may be freely set/changed/added anywhere and at anytime. In addition, the smart home controls of various scenarios according to the setting/changing/adding of the control values may be performed; a group control by a network configuration as well as a separate control may also be performed; and the smart home control may be directly performed by user manipulation such as the mechanical buttons or switches. Therefore, the elderly, children, and those who are unaccustomed to using electronic devices, such as smartphones, may also easily perform the smart home control.

While embodiments have been shown and described above, it will be apparent to those skilled in the art that modifications and variations could be made without departing from the scope of the present invention as defined by the appended claims.

The image display apparatus described herein may be implemented using a liquid crystal display (LCD), a light-emitting diode (LED) display, a plasma display panel (PDP), a screen, a terminal, or any other type of display known to one of ordinary skill in the art. A screen may be a physical structure that includes one or more hardware components that provide the ability to render a user interface and receive user input. The screen may include any combination of a display region, a gesture capture region, a touch-sensitive display, and a configurable area. The screen may be part of an apparatus, or may be an external peripheral device that is attachable to and detachable from the apparatus. The display may be a single-screen display or a multi-screen display. A single physical screen may include multiple displays that are managed as separate logical displays permitting different content to be displayed on separate displays even though they are part of the same physical screen.

The user interface may provide the capability of inputting and outputting information regarding a user and an image. The user interface may include a network module for connecting to a network and a universal serial bus (USB) host module for forming a data transfer channel with a mobile storage medium. In addition, the user interface may include one or more input/output devices, such as a mouse, a keyboard, a touch screen, a monitor, a speaker, a screen, or a software module for controlling the input/output device.

The apparatuses, units, modules, devices, and other components illustrated in FIGS. 1-4 that perform the operations described herein with respect to FIGS. 1-4 are implemented by hardware components. Examples of hardware components include controllers, wired communicators, wireless communicators, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1-4. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, micro processor (MCU), a digital signal processor (DSP), single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 3-4 that perform the operations described herein with respect to FIGS. 1-4 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

As a non-exhaustive example only, a smartphone or mobile terminal as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

A terminal as described herein, which may be referred to as a computer terminal, may be an electronic or electromechanical hardware device that is used for entering data into and displaying data received from a host computer or a host computing system. A terminal may be limited to inputting and displaying data, or may also have the capability of processing data as well. A terminal with a significant local programmable data processing capability may be referred to as a smart terminal or fat client. A terminal that depends on the host computer or host computing system for its processing power may be referred to as a dumb terminal or thin client. A computer may run terminal emulator software that replicates the function of a terminal, sometimes allowing concurrent use of local programs and access to a distant terminal host system.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A smart home control system comprising:
a mechanical button;
an external programming terminal; and
a controller configured to receive and store a control value from the external programming terminal, and generate and output a smart home control signal according to the control value,
wherein an operating state of the button is determined by the smart home control signal.

2. The smart home control system of claim 1, further comprising:
a wireless communicator configured to wirelessly receive the control value from the external programming terminal and wirelessly transmitting the smart home control signal;
a wired communicator configured to receive the control value from the external programming terminal through a wired connection;
a memory storing the control value and data necessary to perform a control process of the controller; and
a power supply providing operating power to the smart home control system.

3. The smart home control system of claim 2, further comprising a display configured to display the operating state of the button, a power level of the power supply, and an operating state of the controller.

4. The smart home control system of claim 1, wherein the controller is configured to block the reception of the control value from the external programming terminal when the smart home control signal is output.

5. The smart home control system of claim 1, wherein the button is a switch or function key.

6. The smart home control system of claim 1, wherein the controller is configured to switch to a control value reception mode for receiving the control value when the button is pressed for a predetermined amount of time.

7. The smart home control system of claim 2, further comprising a bridge assigning a separate identification to a target controlled by the smart home control signal.

8. The smart home control system of claim 1, further comprising a plurality of buttons,
wherein each button of the plurality of buttons controls a group components

9. A smart home control method comprising:
generating a control value corresponding to an operating state of each of a plurality of mechanical buttons;
receiving and storing the control value from an external programming terminal; and
generating and outputting a smart home control signal according to the operating state of each button on the basis of the stored control value.

10. The smart home control method of claim 8, wherein the control value is received via wired or wireless communications with the external programming terminal.

11. The smart home control method of claim 8, wherein the reception of the control value from the external programming terminal is blocked during the generating and outputting of the smart home control signal.

12. The smart home control method of claim 8, further comprising switching to a control value reception mode for receiving the control value when a button is pressed for a predetermined time.
